(19) United States
(12) Patent Application Publication
(10) Pub. No.: US 2014/0287185 A1
(43) Pub. Date: Sep. 25, 2014

(54) PARTICULATE FILLERS

(71) Applicant: Imerys Minerals Limited, Par Cornwall (GB)

(72) Inventors: David John Moseley, Cornwall (GB); Michael George Truscott, Par (GB); Allen George Webb, Par (GB); Anabelle Huguette Renee Legrix, Cornwall (GB)

(21) Appl. No.: 14/353,835

(22) PCT Filed: Oct. 25, 2012
(86) PCT No.: PCT/GB2012/052658

§ 371 Date: Apr. 24, 2014

(30) Foreign Application Priority Data
Oct. 25, 2011 (GB) 1118442.1
Feb. 29, 2012 (GB) 1203536.6

(51) Int. Cl. C08K 3/26

(52) U.S. Cl. CPC C08K 3/26; C08K 2003/265
USPC 428/87; 428/402; 428/403; 428/220; 442/365; 524/425

(57) ABSTRACT

Particulate fillers possess no, or very low, amounts of coarse particles. The particulate fillers may be included in compositions, such as polymer compositions including polymer film formed from a polymer composition, such as breathable film. The particulate fillers may be included in spunlaid fiber, and the spunlaid fiber may be included in products and non-woven fabric. The particulate filler may be included in staple fibers, which may be included in carpet.

### FIELD OF THE INVENTION

The present invention relates to particulate fillers which possess no, or very low, amounts of coarse material, compositions comprising said fillers and uses thereof. The present invention also relates to methods of producing said particulate fillers and compositions.

### BACKGROUND OF THE INVENTION

The use of processed minerals in various applications is known. For example, it is known to use processed minerals in applications such as paper products, coatings, e.g. paints, and polymer compositions.

A significant amount of research has gone into developing processed minerals with particular particle size distributions (psd) as the particle size distribution typically has an effect on the properties of the composition in which the mineral may be incorporated for a particular application. When expressing the psd of a particulate material this often includes reference to a so-called “top cut”. The top cut may refer to the particle diameter at which 98% (or 99%) of the particles in the sample of filler have a smaller diameter than the stated value. For example, a filler having a top cut of 10 μm or less may be taken to mean that 98% of the particles in the sample of the filler have a smaller diameter than 10 μm. This means that about 2% of the particles will have a particle size which is higher than the top cut. The methods typically used to measure the top cut are usually sensitive to about 100 ppm or above.

The present inventors have surprisingly found that very low levels of particles above a particular size, which may be referred to herein as “coarse material”, (or as “hard material”), which are present in fillers, e.g. processed minerals, may be detrimental for a range of applications in which the filler may be used; in particular those where fillers are incorporated into polymer compositions. For example, the present inventors have discovered that only a few ppm of coarse particles present in a material intended for use in a polymer fibre based application resulted in an undesirable rise in pressure when the polymer fibre was being extruded. The present invention is based at least partly on this finding and, as such, the present inventors have found that it would be desirable to provide particulate fillers, with no or very low amounts of coarse material (or hard material).

### SUMMARY OF THE INVENTION

In a first aspect, the present invention provides a particulate filler comprising less than about 3 ppm of particles having a particle size greater than or equal to about 40 μm.

The particulate filler may be suitable for use in a range of applications. For example, the filler in accordance with the first aspect of the invention may be suitable for use in paper products, coatings, for example paint or barrier coatings but more particularly in polymer compositions, polymer films (particularly breathable films), polymer fibres, for example spunlaid fibres and nonwoven products. The filler in accordance with the first aspect of the invention may also be used in staple fibers and carpet.

Accordingly, in a further aspect, the present invention provides a composition comprising a particulate filler in accordance with the first aspect of the invention, i.e. a composition comprising a particulate filler comprising less than about 3 ppm of particles having a particle size greater than or equal to about 40 μm.

The composition may be a polymer composition which may comprise a polymer resin and the polymer composition may be formable or formed into a polymer film (for example a breathable film). Alternatively, the polymer composition may be formable or formed into a polymer fibre (e.g. a spunlaid fibre) or a nonwoven product.

Accordingly, in further aspects, the present invention provides a polymer composition comprising a polymer resin and a particulate filler comprising less than about 3 ppm of particles having a particle size greater than or equal to about 40 μm.

Certain embodiments of the present invention also provide a staple fiber comprising less than about 3 ppm of particles having a particle size greater than or equal to about 40 μm. Certain embodiments of the present invention also provide a carpet comprising said staple fibre or a carpet comprising less than about 3 ppm of particles having a particle size greater than or equal to about 40 μm. As used herein, “staple fibers” refer to discrete fibers having a particular length. For example, the staple fibers may have a length ranging from about 25 mm to about 150 mm. In other instances, the staple fiber may have a length ranging from about 35 mm to about 100 mm. In still other instances, the staple fiber may have a length ranging from about 50 mm to about 75 mm.

In further aspects of the present invention, there are provided methods of making the compositions, polymer compositions, films and other polymer based products in accordance with the invention. There are also provided methods of making the staple fibre and carpet in accordance with some embodiments of the invention. Therefore, according to a further aspect of the present invention, there is provided a production process for said polymer compositions comprising blending a polymer or precursor of polymer with a particulate filler comprising less than about 3 ppm of particles having a particle size greater than or equal to about 40 μm. The composition may then be formed into the polymer film or a nonwoven product or a polymer fibre (e.g. a spunlaid fibre). The polymer film may be a breathable film. There is also provided a method or a production process for making a staple fibre comprising combining a staple fibre with a particulate filler comprising less than about 3 ppm of particles having a particle size greater than or equal to about 40 μm. The staple fiber may then be formed into or used in portions of a carpet.

The term “precursor” as applied to a polymer component will be readily understood by one of ordinary skill in the art. For example, suitable precursors may include one or more of: monomers, cross-linking agents, curing systems comprising cross-linking agents and promoters, or any combination thereof. Where, according to the invention the filler is mixed with precursors of the polymer, the polymer composition may subsequently be formed by curing and/or polymerising the precursor components to form the desired polymer.

The polymer film can be suitably used in packaging products, including food packaging products and consumer packaging products.

The filler may comprise, consist of or consist essentially of alkaline earth metal carbonate, (for example dolomite, i.e. CaMg(CO₃)₂ or calcium carbonate), metal sulphate, (for example barite or gypsum), metal silicate, metal oxide (for example titania, iron oxide, chromia, antimony trioxide or silica), metal hydroxide (for example alumina trihydrate), kaolin, calcined kaolin, wollastonite, bauxite, talc or mica, including combinations thereof. Any of the aforementioned materials may be coated (or uncoated) or treated (or untreated). In particular, the filler may comprise, consist of or consist essentially of coated calcium carbonate, treated calcined kaolin or treated talc. Hereafter, the invention may tend to be discussed in terms of calcium carbonate or coated calcium carbonate, and in relation to aspects where the calcium carbonate or coated calcium carbonate is processed and/or treated. The invention should not be construed as being limited to such embodiments.

The filler may be coated. For example, the filler may be coated with a hydrophobising surface treatment agent. In particular, the calcium carbonate may be coated. For example, the calcium carbonate may be coated with one or more aliphatic carboxylic acids having at least 10 chain carbon atoms. For example, the calcium carbonate may be coated with one or more fatty acids, including salts or esters thereof. The fatty acids may be selected from stearic acid, palmitic acid, behenic acid, montanic acid, capric acid, lauric acid, myristic acid, isostearic acid and cerotic acid. The coated calcium carbonate may be a stearate coated calcium carbonate. The coated calcium carbonate may be stearate coated ground natural calcium carbonate (GCC) or stearate coated precipitated calcium carbonate (PCC).

The calcined kaolin may be treated with an organo-silane or a propylene glycol. The talc may be treated with a silane, for example an organo-silane.

The particulate filler may have a mean equivalent particle diameter (d₅₀) ranging from about 0.5 μm to about 5 μm, for example about 1 μm to about 3 μm, for example about 2 μm or about 1.5 μm or about 1 μm.

The present inventors have found that the particulate filler possessing the low coarse particle content in accordance with the present invention may be made using a dry sieving method, for example a sifting method.

Therefore, in a further aspect, the present invention provides a method of removing particles from a particulate material comprising:

dry sieving (e.g. sifting) the particulate material to produce a particulate filler comprising less than about 3 ppm of particles having a particle size greater than or equal to about 40 μm. The sifter may be a centrifugal or rotary sifter. The sieve or sifter may comprise a mesh screen possessing holes of an appropriate size. For example, the mesh screen size may possess square holes. The mesh screen may possess a hole size of 53 μm, 48 μm, 41 μm, 30 μm, 25 μm, 20 μm or 15 μm. The mesh screen may be made of nylon or other appropriate material such as stainless steel.

The present inventors have also found that the particulate filler possessing the low coarse particle content in accordance with the present invention may be made using a mill classifier.

Therefore, in a further aspect, the present invention provides a method of removing particles from a particulate material comprising:

mill classifying the particulate material to produce a particulate filler comprising less than about 3 ppm of particles having a particle size greater than or equal to about 40 μm.

The present inventors have also found that the particulate filler possessing the low coarse particle content in accordance with the present invention may be made using an air classifier.

Therefore, in a further aspect, the present invention provides a method of removing particles from a particulate material comprising:

air classifying the particulate material to produce a particulate filler comprising less than about 3 ppm of particles having a particle size greater than or equal to about 40 μm.

With respect to the various aspects and embodiments of the present invention, the filler may comprise less than about 3 ppm of particles having a particle size greater than about 38 μm, or greater than about 30 μm, or greater than about 25 μm or greater than about 20 μm. These particles and those particles having a particle size greater than or equal to about 40 μm may be described herein as “coarse particles” or “coarse material” or as “hard particles” or “hard material”.

Also, with respect to the various aspects and embodiments of the present invention, the coarse particle content may range from: less than or equal to about 2 ppm; less than or equal to about 1 ppm; less than or equal to about 0.5 ppm; less than or equal to about 0.2 ppm. The coarse particle content may range from 0 ppm or about 0 ppm to about 2 ppm, or may range from 0 ppm or about 0 ppm to about 1 ppm, or may range from 0 ppm or about 0 ppm to about 0.5 ppm, or may range from 0 ppm or about 0 ppm to about 0.2 ppm. In all of the preceding ranges the lower limit of coarse particle content may be about 0.1 ppm.

With respect to the various aspects and embodiments of the invention, the particulate filler may be a particulate mineral. The particulate mineral may be a processed particulate mineral.

In order to determine the amount of coarse particles present, the particulate filler is suspended in a liquid in which the filler does not aggregate. The present inventors have found that a suitable liquid is isopropyl alcohol, which may be referred to herein as propan-2-ol or simply IPA. The suspension is then fed through a suitably sized meshed screen possessing square holes. The screen residue is left to dry at room temperature and the retained residue removed and weighed. The amount of residue compared to the initial sample weight allows for the characterisation of the amount of coarse particles in ppm. The sieved (or sifted) material and the screen residue may be analysed using optical microscopy.

There are numerous advantages associated with the present invention. For example, use of the filler in accordance with the present invention provides improved processability in various applications. For instance, when the particulate filler is incorporated in polymer compositions which are processed in extruders or spinnerets, screen components of such equipment do not, or seldom, become clogged by the particulate filler. Inclusion of the particulate filler into polymer films gives rise to a reduction in the number of film defects per area of processed film, particularly when the film thickness is reduced (down gauge). Use of the filler in accordance with the present invention provides improved mechanical performance, for example in relation to impact strength and/or tear strength.

### DETAILED DESCRIPTION OF THE INVENTION

### Particulate Filler

Suitable fillers include particulate inorganic fillers. For example, mineral fillers such as alkaline earth metal carbonate, (for example dolomite, i.e. CaMg(CO₃)₂, or calcium carbonate), metal sulphate, (for example barite or gypsum), metal silicate, metal oxide (for example titania, iron oxide, chromia, antimony trioxide or silica), metal hydroxide (for example alumina trihydrate), kaolin, calcined kaolin, wollastonite, bauxite, talc or mica, including combinations thereof. Any of the aforementioned materials may be coated (or uncoated) or treated (or untreated). In particular, the filler may comprise, consist of or consist essentially of coated calcium carbonate, treated calcined kaolin or treated talc. Other suitable fillers may include those with a low moisture pick-up. The filler may be a single filler or may be a blend of fillers. For example, the filler may be a blend of two or more of the fillers listed herein.

The particulate filler may have a mean particle size (d₅₀) from about 0.5 μm to about 5 μm, for example from about 1 μm to about 3 μm, for example about 1 μm or about 1.5 μm or about 2 μm. The particulate filler may have a d₉₈ of about 8 μm or less than about 8 μm, for example about 4 μm to about 8 μm, or about 4 μm to about 5 μm, or about 5 μm to about 6 μm or about 6 μm to about 8 μm. The particulate filler may have a d₉₀ of about 5 μm or less, or about 4 μm or less. For example, the particulate filler may have a d₉₀ of about 3 μm to about 5 μm or about 3 μm to about 4 μm. Particular examples of particle size distributions are: d₉₀ equal to about 4 μm and d₉₈ equal to about 8 μm; d₉₀ equal to about 3 μm to about 4 μm and d₉₈ equal to about 6 μm to about 8 μm; d₉₀ equal to about 3 μm to about 4 μm and d₉₈ equal to about 4 μm to about 5 μm; d₉₀ equal to about 3 μm to about 5 μm and d₉₈ equal to about 5 μm to about 8 μm or about 5 μm to about 6 μm.

Unless otherwise stated, particle size properties referred to herein for the particulate fillers or materials are as measured in a well known manner by sedimentation of the particulate filler or material in a fully dispersed condition in an aqueous medium using a Sedigraph 5100 machine as supplied by Micromeritics Instruments Corporation, Norcross, Ga., USA (telephone: +17706623620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value. The d₉₈ and the d₉₀ are the values determined in this way of the particle e.s.d. at which there are 98% and 90% respectively by weight of the particles which have an equivalent spherical diameter less than that d₉₈ or d₉₀ value.

The particulate calcium carbonate used in the present invention may be obtained from a natural source by grinding or may be prepared synthetically by precipitation (PCC), or may be a combination of the two, i.e. a mixture of the naturally derived ground material and the synthetic precipitated material. The PCC may also be ground.

Ground calcium carbonate (GCC), i.e. ground natural calcium carbonate is typically obtained by grinding a mineral source such as chalk, marble or limestone, which may be followed by a particle size classification step, in order to obtain a product having the desired degree of fineness. The particulate solid material may be ground autogenously, i.e. by attrition between the particles of the solid material themselves, or alternatively, in the presence of a particulate grinding medium comprising particles of a different material from the calcium carbonate to be ground.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

When the filler is obtained from naturally occurring sources, it may be that some mineral impurities will inevitably contaminate the ground material. For example, naturally occurring calcium carbonate occurs in association with other minerals. Also, in some circumstances, minor additions of other minerals may be included, for example, one or more of kaolin, calcined kaolin, wollastonite, bauxite, talc or mica, could also be present. In general, however, the filler used in the invention will contain less than 5% by weight, preferably less than 1% by weight of other mineral impurities.

PCC may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process, the milk of lime is contacted with soda ash to produce, by double decomposition, a precipitate of calcium carbonate and a solution of sodium hydroxide. The sodium hydroxide must be substantially completely separated from the calcium carbonate if this process is to be commercially attractive. In the third main commercial process, the milk of lime is first contacted with ammonium chloride to give a calcium chloride solution and ammonia gas. The calcium chloride solution is then contacted with soda ash to produce, by double decomposition, precipitated calcium carbonate and a solution of sodium chloride.

The process for making PCC results in very pure calcium carbonate crystals and water. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Following the grinding process, the particulate filler may have a d₅₀ in the range of about 0.5 μm to about 5 μm. The filler, following grinding may have a d₅₀ of less than or equal to about 2 μm, for example less than or equal to about 1.5 μm, for example less than or equal to about 1 μm. When used in a polymer film, the maximum size of the particles is typically less than the thickness of the film.

Optionally, the particulate filler may be coated. For example, the calcium carbonate (GCC or PCC) may be coated with a hydrophobising surface treatment agent. For example, the calcium carbonate may be coated with one or more aliphatic carboxylic acids having at least 10 chain carbon atoms. For example, the calcium carbonate may be coated with one or more fatty acids or salts or esters thereof. The fatty acids may be selected from stearic acid, palmitic acid, behenic acid, montanic acid, capric acid, lauric acid, myristic acid, isostearic acid and cerotic acid. The coated calcium carbonate may be a stearate coated calcium carbonate. The inventors of the present invention have found that stearate coated calcium carbonate is particularly effective, even more particularly stearate coated GCC. The level of coating may be about 0.5 wt % to about 1.5 wt %, for example about 0.8 wt % to about 1.3 wt % based on the dry weight of the particulate filler.

Other suitable coated or treated fillers include treated calcined kaolin and treated talc. The calcined kaolin may, for example, be treated with a silane (e.g. an organo-silane) or propylene glycol, while talc may be treated with a silane (e.g. an organo-silane).

The filler may be dried prior to inclusion in a composition. For example, the filler may be dried before being combined with a polymer resin. Typically, the filler may be dried in a conventional oven at about 80° C. The polymer may be dried in a vacuum oven at approximately 80° C. The particulate filler may be dried to an extent such that the particulate filler has and maintains an adsorbed water (or moisture) content not greater than about 0.5 wt %, for example and particularly advantageously, not greater than about 0.1 wt % based on the dry weight of the particulate filler. This includes both uncoated and coated particulate fillers. Low levels of adsorbed water are particularly beneficial when the filler is used to form breathable films.

Desirably, the particulate filler, including when either coated or uncoated, is not susceptible to further substantial moisture pick-up. The particulate filler may, for example, have a moisture level not greater than about 0.5 wt %, for example not greater than about 0.1 wt % after exposure to an atmosphere of 80% or more relative humidity for 40 hours at a temperature of 20° C.

The particulate filler may be free or substantially free of hygroscopic or hydrophilic compounds. For example, during grinding of the particulate filler, the grinding may be carried out in the absence of added hygroscopic or hydrophilic compounds, or if wet ground, any dispersant employed may be minimised and/or subsequently removed from the filler in a known manner. For example, not greater than about 0.05 wt % of a hydrophilic component may be present on the particulate filler based on the dry weight of the particulate filler. For example, not greater than about 0.05 wt % of a dispersant, for example, a hydrophilic dispersant, may be present on the particulate filler based on the dry weight of the particulate filler. An example of such a dispersant is sodium polyacrylate. The moisture level may be measured in a known manner, e.g. by a Karl Fischer (KF) titration apparatus. In this method, the water may be driven off from the sample by heating and then measured using the quantitative reaction of water with iodine. In coulometric KF titration, the sample is added to a pyridine-methanol solution (with iodine and sulphur dioxide as principal components). The iodine generated electrolytically at the anode, reacts with water. The amount of water can be directly determined from the quantity of electric charge required for electrolysis.

The amount of coarse material present in the particulate filler may be reduced to very low values or zero. This may be achieved by the use of a sieve or sifter, for example a centrifugal sifter which may be referred to as a rotary sifter. The sieve or sifter may comprise a fine mesh screen. The fine mesh screen may possess equally sized and equally spaced holes which may be square. The holes may be rectangular or slot shaped. The mesh screen may be made of nylon or metal wire. The mesh screen may be a fine woven screen or a laser ablated screen. The use of suitable mesh screens results in the levels of coarse particles being reduced to very low levels while retaining good process rates or throughput. The amount of coarse particles present following sieving or sifting may be 0 ppm or about 0 ppm to about 2 ppm, or may range from 0 ppm or about 0 ppm to about 1 ppm, or may range from 0 ppm or about 0 ppm to about 0.5 ppm, or may range from 0 ppm or about 0 ppm to about 0.2 ppm. In all of the preceding ranges the lower limit of coarse particle content may be about 0.1 ppm. The coarse particles may have a particle size greater than or equal to about 40 μm or greater than about 38 μm or greater than about 30 μm or greater than about 25 μm or greater than about 20 μm.

The present invention is based partly on the finding that only a few ppm of coarse particles in a particulate filler may be detrimental when using said filler in various applications, including in polymer compositions which may subsequently be used for forming polymer films (e.g. breathable polymer films) and nonwoven products which may incorporate spunlaid fibres and the like. These detrimental effects may be in relation to the processing itself or in connection with the performance of the final product. Hitherto, sieving and sifting techniques have only been used on coarse materials including foodstuffs, such as flour or wheat, which would typically have a significantly higher particle size than those considered in connection with the present invention.

By using a dry sieving technique, in particular a centrifugal sifter, particulate fillers possessing a d₅₀ of about 0.5 μm to 5 μm (e.g. 1.5 μm) may be screened at about 1 t/hr (tonne per hour) with very high recovery levels. Suitable recovery levels (product/feed×100) include, for example, greater than about 90% and up to recovery levels greater than about 96% or greater than about 99% and may be up to about 100%. Suitable throughputs are, for example at least about 1 t/hr, or at least 2 t/h.

Suitable examples of sifters include rotary sifters, such as the centrifugal (rotary) sifters available from Kek-Gardner (Kek-Gardner Ltd, Springwood Way, Macclesfield, Cheshire SK10 2^{ND}; www.kekgardner.com). An example of a suitable range of sifter available from Kek-Gardner is the K range of centrifugal rotary sifters. For example, the K650C is a small pilot machine with a 650 mm length of drum and the K1350 possesses a drum length of 1350 mm. The sifter may be fitted with a screen possessing a suitable mesh size. The screen may be a fine woven screen or a laser ablated screen. The screen may be made from nylon or stainless steel. Other suitable rotary (or centrifugal) sifters may be obtained from KASON (KASON Corporation, 67-71 East Willow Street, Millburn, N.J., USA; www.kason.com) and SWECO (SWECO, PO Box 1509, Florence, Ky. 41022, USA; www.sweco.com).

In a typical centrifugal sifter, material is fed into the feed inlet and redirected into the cylindrical sifting chamber by means of a feed screw. Rotating, helical paddles within the chamber continuously propel the material against a mesh screen, while the resultant, centrifugal force on the particles accelerates them through the apertures. These rotating paddles, which do not make contact with the screen, also serve to breakup soft agglomerates. Most over-sized particles and trash are ejected via the oversize discharge spout. Typically, centrifugal sifters are designed for gravity-fed applications, and for sifting in-line with pneumatic conveying systems. Suitable sifters include single and twin models and those available with belt drive or direct drive. The units may be freestanding or adapted for easy mounting on new or existing process equipment. Removable end housings allow for rapid cleaning and screen changes.

In other embodiments, the amount of coarse material present in the particulate filler may be reduced to very low values or zero by the use of a mill classifier, for example a dynamic mill classifier or a cell mill fitted with a classifier. The mill classifier may comprise block rotors, blade rotors, and/or a blade classifier. The amount of coarse particles present following processing through the mill classifier may be 0 ppm or about 0 ppm to about 4 ppm, or may range from 0 ppm or about 0 ppm to less than or about 3 ppm, or may range from 0 ppm or about 0 ppm to about 2 ppm, or may range from 0 ppm or about 0 ppm to about 1 ppm, or may range from 0 ppm or about 0 ppm to about 0.5 ppm. In all of the preceding ranges the lower limit of coarse particle content may be about 0.1 ppm. The coarse particles may have a particle size greater than or equal to about 40 μm or greater than about 38 μm or greater than about 30 μm or greater than about 25 μm or greater than about 20 μm.

By using a mill classifier, particulate fillers may be processed at greater than about 30 kg/h or more, 130 kg/h or more, 180 kg/h or more, 300 kg/h or more, 350 kg/h or more, or 450 kg/h or more (for example at least 1000 kg/h, or at least 5000 kg/h or at least 6000 kg/h) with very high recovery levels. Suitable recovery levels (product/feed×100) include, for example, greater than or about 40%, greater than about 70%, greater than about 80% and up to recovery levels greater than about 96% or greater than about 99% and may be up to about 100%.

Suitable examples of mill classifiers include dynamic mill classifiers and cell mills fitted with a classifier. These are available from Atritor (Atritor Limited, Coventry, West Midlands, England; www.atritor.com), a suitable example being the multirotor cell mill.

In still other embodiments, the amount of coarse material present in the particulate filler may be reduced to very low values or zero by the use of an air classifier. The air classifier may be used in conjunction with a cyclone and/or filter. The amount of coarse particles present following processing through the air classifier may be 0 ppm or about 0 ppm to about 4 ppm, or may range from 0 ppm or about 0 ppm to less than or about 3 ppm, or may range from 0 ppm or about 0 ppm to about 2 ppm, or may range from 0 ppm or about 0 ppm to about 1 ppm, or may range from 0 ppm or about 0 ppm to about 0.5 ppm. In all of the preceding ranges the lower limit of coarse particle content may be about 0.1 ppm. The coarse particles may have a particle size greater than or equal to about 40 μm or greater than about 38 μm or greater than about 30 μm or greater than about 25 μm or greater than about 20 μm.

By using an air classifier, particulate fillers may be processed at greater than 300 kg/h or more, 350 kg/h or more, or 450 kg/h or more with very high recovery levels. Suitable recovery levels (product/feed×100) include, for example, greater than about 60%, greater than about 70%, greater than about 80%, greater than about 90%, and up to recovery levels greater than about 96% or greater than about 99% and may be up to about 100%.

Suitable examples of air classifiers are available from Comex (Comex Polska Sp. z o. o., Krakow, Poland, www.comex-oroup.com).

### Applications

The particulate fillers may be used in numerous applications including in paper products, coatings, for example paint or barrier coatings but more particularly in polymer compositions, polymer films (e.g. breathable polymer films), polymer fibres, for example spunlaid fibres and nonwoven products.

### Polymer Films

The particulate fillers in accordance with the present invention may be incorporated in polymer compositions which may be formable or formed into polymer films. Advantageously, the particulate filler may be used to form a breathable polymer film.

The polymer film comprises a polymer and a particulate filler. The polymer film is formable from a polymer composition comprising a polymer resin and a filler. The particulate filler may be a mineral filler. The polymer to be filled in accordance with the present invention may be a homopolymer or a copolymer. Suitable polymer resins include thermoplastic resins such as polyolefin resin, for example, including mono-olefin polymers of ethylene, propylene, butene or the like, functionalized derivatives and physical blends and copolymers of the same. Typical examples of the polyolefin resin include polyethylene resins such as a low-density polyethylene, linear low density polyethylene (ethylene-a-olefin copolymer), middle-density polyethylene and high-density polyethylene; polypropylene resins such as polypropylene and ethylene-polypropylene copolymer; poly(4-methylpentene); polybutene; ethylene-vinyl acetate copolymer; and mixtures thereof. These polyolefin resins may be obtained by polymerisation in a known way, e.g. by the use of a Ziegler catalyst, or obtained by the use of a single site catalyst such as a metallocene catalyst.

Before use, the polymer resin may be dried until a required level of dryness is attained.

Optionally, the polymer film may further comprise one or more additives. Examples of useful additives include, but are not limited to, opacifying agents, pigments, colorants, slip agents, antioxidants, anti-fog agents, anti-static agents, anti-block agents, moisture barrier additives, gas barrier additives, hydrocarbon resins or hydrocarbon waxes.

The particulate filler, which may or may not have been surface treated, may be incorporated in polymer compositions and is typically present at a concentration of about 2 to 55 wt % by weight of the final polymer film, for example, about 5 to 50 wt %, for example, about 10 to 25 wt %. For use in breathable films, the particulate filler, which may or may not have been surface treated, may be incorporated in polymer compositions and is typically present at a concentration of about 30 wt % to about 55 wt % by weight of the final polymer film, for example, about 45 wt % to about 55 wt %. The polymer composition comprises at least one polymer resin. The term resin means a polymer material, either solid or liquid, prior to shaping into an article such as a polymer film. The polymer resin and filler material may be independently dried prior to mixing.

The polymer resin may be melted (or otherwise softened) prior to formation of the polymer film, and the polymer will not normally be subjected to any further chemical transformations. After formation of the polymer film, the polymer resin is cooled and allowed to harden.

The polymer composition may be made by methods which are well known in the art generally in which a particulate filler and a polymer resin are mixed together in suitable ratios to form a blend (so-called “compounding”). The polymer resin may be in a liquid form to enable the particles of the filler to be dispersed therein. Where the polymer resins are solid at ambient temperatures, the polymer resin may need to be melted before the compounding can be accomplished. In some embodiments, the particulate filler may be dry blended with particles of the polymer resin, dispersion of the particles in the resin then being accomplished when the melt is obtained prior to forming a film from the melt, for example in an extruder itself.

In embodiments of the invention, the polymer resin and the particulate filler and, if necessary, any other optional additives, may be formed into a suitable masterbatch by the use of a suitable compounder/mixer in a manner known per se, and may be pelletized, e.g. by the use of a single screw extruder or a twin-screw extruder which forms strands which may be cut or broken into pellets. The compounder may have a single inlet for introducing the filler and the polymer resin together. Alternatively, separate inlets may be provided for the filler and the polymer resin. Suitable compounders are available commercially, for example from Coperion (formerly Werner & Pfleiderer).

The polymer compositions according to the present invention can be processed to form, or to be incorporated in, polymer films in any suitable way. Methods of making polymer films are well known to those of ordinary skill in the art and may be prepared in a conventional manner. Known methods include the use of casting, extruding and blowing processes. For example, extrusion blown film lines may be used. For those instances where combinations of polymers are used, then co-extrusion techniques may be used. Methods of co-extrusion are well known to the person of ordinary skill. Typically, two or more streams of molten polymer resin are joined into a single extrudate stream in such a way that the resins bond together but do not mix. Generally, a separate extruder is required for each stream and the extruders are linked so that the extrudates can flow together in an appropriate manner for the desired application. For making layered films, several extruders may be used in combination and fed together into a complex die that will merge each of the resin streams into a layered film or sandwich material.

The films made according to the present invention may be of a size and thickness appropriate to the final application. For example, the mean thickness of the film may be less than about 250 μm, for example, about 5 μm to less than about 250 μm, for example about 30 μm. For breathable films, the thickness of the film may be about 5 μm to about 25 μm, for example about 8 μm to about 18 μm for example about 10 μm to about 15 μm. The ability to provide thin breathable films represents a particular advantage of the present invention.

The use of fillers in breathable films is described in WO 99/61521 and U.S. Pat. No. 6,569,527 B1 the contents of which are incorporated herein in their entirety by reference.

In the manufacture of a breathable film a blend or masterbatch of the resin (e.g. thermoplastic polyolefin resin) and the filler may first be produced by mixing and compounding prior to the film production stages. The mixture of ingredients to be blended by compounding may include, in addition to the resin and the particulate filler, other known optional ingredients employed in thermoplastic films, e.g. one or more of bonding agents, plasticisers, lubricants, anti-oxidants, ultraviolet absorbers, dyes, colourants. A bonding or tackifying agent where employed may facilitate bonding of the film after formation to another member, e.g. a nonwoven fibrous layer, or one or more non porous layers.

The resin, the filler and, if necessary, other optional additives, may be mixed by the use of a suitable compounder/mixer e.g. a Henschel mixer, a super mixer, a tumbler type mixer or the like, and kneaded and may be pelletized, e.g. by the use of a single screw extruder or a twin-screw extruder which forms strands which may be cut or broken into pellets. The masterbatch or blend, e.g. in the form of pellets, may be melted and moulded or shaped into a film by the use of a known moulding and film forming machine.

The film may be a blown film, cast film or extruded film. The film as initially formed may be generally too thick and too noisy as it tends to make a rattling sound when shaken and the film may not yet have a sufficient degree of breathability as measured by its water vapour transmission rate. Consequently, the film may be heated, e.g. to a temperature of about 5° C. less than the melting point of the thermoplastic polymer or more, and then stretched to at least about 1.2 times, for example at least about 2.5 times, its original length to thin the film and make it porous.

An additional feature of the thinning process is the change in opacity of the film. As formed, the film is relatively transparent but after stretching, it becomes opaque. In addition, while the film becomes orientated during the stretching process, it also becomes softer and it does not have the degree of rattle that it does prior to stretching. Taking all these factors into consideration, and the desire to have a water vapour transmission rate of, for example, at least 100 grams per square metre per 24 hours, the film may, for example, be thinned to such an extent that it has a weight per unit area of less than about 35 grams per square metre for personal care absorbent article applications and a weight per unit area of less than about 18 grams per square metre for certain other applications.

The moulding and film forming machine may, for example, comprise an extruder equipped with a T-die or the like or an inflation moulding machine equipped with a circular die. The film production may be carried out at some time after the masterbatch production, possibly at a different manufacturing plant. In some cases, the masterbatch can directly be formed into the film without producing an intermediate product, e.g. by pelletizing.

The film can be stretched in at least a uniaxial direction at a temperature of from room temperature to the softening point of the resin in a known manner such as a roll method or a tenter method to bring about the interfacial separation of the resin and the particulate filler from each other, whereby a porous film can be prepared. The stretching may be carried out by one step or by several steps. Stretch magnification determines film breakage at high stretching as well as breathability and the moisture vapour transmission of the obtained film, and so excessively high stretch magnification and excessively low stretch magnification are desirably avoided. The stretch magnification is preferably in the range of about 1.2 to 5 times, for example about 1.2 to 4 times in at least a uniaxial direction. If biaxial stretching is carried out, it is possible that, for example, stretching in a first direction is applied in the machine direction or a direction perpendicular thereto, and stretching in a second direction is then applied at right angles to the first direction. Alternatively, the biaxial stretching may be carried out simultaneously in the machine direction and the direction perpendicular thereto.

After the stretching, a heat setting treatment may be carried out if required in order to stabilise the shape of obtained voids. The heat setting treatment may be, for example, a heat setting treatment at a temperature in the range of from the softening point of the resin to a temperature less than the melting point of the resin for a period of about 0.1 to about 100 seconds. The thickness should preferably be such as to obtain film unlikely to tear or break and which has appropriate softness and good feel.

For the purposes of the present invention, a film is breathable if it has a water vapour transmission rate of at least 100 g/m²/24 hours as calculated using the test method described in U.S. Pat. No. 5,695,868 (the contents of which are hereby incorporated in their entirety by reference). The breathable film may have a water vapour transmission rate of at least 3000 g/m²/24 hours as calculated in accordance with ASTM E96/E96M-05. Generally, once the film is formed, it will have a weight per unit area of less than about 100 grams per square metre and after stretching and thinning its weight per unit area will be less than about 35 grams per square metre and more desirably less than about 18 grams per square metre. The porous film can be suitably utilised in applications requiring softness, for example, as the backing sheet of disposable diapers.

The porous, or breathable, film prepared in accordance with the present invention may have a suitable breathability, moisture vapour transmission and feeling as well as excellent mechanical properties and long-term adhesive properties. Therefore, the breathable film can be suitably used in products such as disposable diapers, body fluid absorbing pads and bed sheets; medical materials such as surgical gowns and base materials for hot compress; clothing materials such as jumpers, rainwear; building materials such as wallpapers and waterproof materials for roofs and house wraps; packaging materials for packaging desiccants, dehumidifying agents, deoxidizers, insecticides, disposable body warmers; packaging materials for keeping the freshness of various articles and foods; separators for the cells; and the like. The breathable film is particularly desirable as a material used in products such as disposable diapers and body fluid absorbing pads. The breathable film may in such products be formed into a composite or laminate with one or more other layers, e.g. a nonwoven fibrous layer, e.g. by an adhesive or bonding agent.

### Polymer Fibres

The particulate fillers in accordance with the present invention may be incorporated in polymer fibres such as spunlaid fibers and nonwoven products. The particulate fillers in accordance with the present invention may also be incorporated in monofilament fibers.

Spunlaid fibers are generally made by a continuous process, in which the fibers are spun and dispersed in a nonwoven web. Two examples of spunlaid processes are spunbonding or meltblowing. In particular, spunbonded fibers may be produced by spinning a polymer resin into the shape of a fiber, for example, by heating the resin at least to its softening temperature, extruding the resin through a spinneret to form fibers, and transferring the fibers to a fiber draw unit to be collected in the form of spunlaid webs. Meltblown fibers may be produced by extruding the resin and attenuating the streams of resin by hot air to form fibers with a fine diameter and collecting the fibers to form spunlaid webs.

Spunlaid fibers may be used to make diapers, feminine hygiene products, adult incontinence products, packaging materials, wipes, towels, dust mops, industrial garments, medical drapes, medical gowns, foot covers, sterilization wraps, table cloths, paint brushes, napkins, trash bags, various personal care articles, ground cover, and filtration media.

The spunlaid fibers disclosed herein comprise at least one polymer resin. The at least one polymer resin may be chosen from conventional polymer resins that provide the properties desired for any particular nonwoven product or application. The at least one polymer resin may be chosen from thermoplastic polymers, including but not limited to: polyolefins, such as polypropylene and polyethylene homopolymers and copolymers, including copolymers with 1-butene, 4-methyl-1-pentene, and 1-hexane; polyamides, such as nylon; polyesters; copolymers of any of the above-mentioned polymers; and blends thereof.

Examples of commercial products suitable as the at least one polymer resin include, but are not limited to: Exxon 3155, a polypropylene homopolymer having a melt flow rate of about 30 g/10 min, available from Exxon Mobil Corporation; PF305, a polypropylene homopolymer having a melt flow rate of about 38 g/10 min, available from Montell USA; ESD47, a polypropylene homopolymer having a melt flow rate of about 38 g/10 min, available from Union Carbide; 6D43, a polypropylene-polyethylene copolymer having a melt flow rate of about 35 g/10 min, available from Union Carbide; PPH 9099 a polypropylene homopolymer having a melt flow rate of about 25 g/10 min, available from Total Petrochemicals; PPH 10099 a polypropylene homopolymer having a melt flow rate of about 35 g/10 min, available from Total Petrochemicals; Moplen HP 561R a polypropylene homopolymer having a melt flow rate of about 25 g/10 min, available from Lyondell Basell.

The particulate filler may be present in an amount less than about 40 wt % relative to the total weight of the fibers. The particulate filler may be present in an amount less than about 25 wt % relative to the total weight of the fibers. The particulate filler may be present in an amount less than about 15 wt % relative to the total weight of the fibers. The particulate filler may be present in an amount less than about 10 wt % relative to the total weight of the fibers. The particulate filler may be present in an amount ranging from about 5 wt % to about 40 wt % relative to the total weight of the fibers. The particulate filler may be present in an amount ranging from about 10 wt % to about 25 wt % relative to the total weight of the fibers. The particulate filler may be present in an amount ranging from about 10 wt % to about 15 wt % relative to the total weight of the fibers.

The at least one polymer resin may be incorporated into the fibers of the present invention in an amount of greater than or equal to about 60 wt % relative to the total weight of the fibers. The at least one polymer resin may be present in the fibers in an amount ranging from about 60 wt % to about 90 wt %. The at least one polymer may be present in the fibers in an amount ranging from about 75 wt % to about 90 wt %. The at least one polymer may be present in the fibers in an amount ranging from about 80 wt % to about 90 wt %. The at least one polymer may be present in the fibers in an amount of greater than or equal to about 75 wt %.

The polymer fibers in accordance with the present invention also comprise a particulate filler. For example, the particulate filler may be any of the fillers listed herein in connection for use in polymer compositions and/or films, particularly, the particulate filler may be coated calcium carbonate or uncoated calcium carbonate. Even more particularly, the filler may be stearate coated GCC or PCC.

The particle size of the filler may affect the maximum amount of filler that can be effectively incorporated into the polymer fibers disclosed herein, as well as the aesthetic properties and strength of the resulting products. The particle size distribution of the filler may be small enough so as to not significantly weaken the individual fibers and/or make the surface of the fibers abrasive, but large enough so as to create an aesthetically pleasing surface texture.

In addition to the polymer resin and the filler, the spunlaid fibers may further comprise at least one additive. The at least one additive may be chosen from additional mineral fillers, for example talc, gypsum, diatomaceous earth, kaolin, attapulgite, bentonite, montmorillonite, and other natural or synthetic clays. The at least one additive may be chosen from inorganic compounds, for example silica, alumina, magnesium oxide, zinc oxide, calcium oxide, and barium sulfate. The at least one additive may be chosen from one of the group consisting of: optical brighteners; heat stabilizers; antioxidants; antistatic agents; anti-blocking agents; dyestuffs; pigments, for example titanium dioxide; luster improving agents; surfactants; natural oils; and synthetic oils.

The spunlaid fibers may be produced according to any appropriate process or processes that results in the production of a nonwoven web of fibers comprising at least one polymer resin. Two exemplary spunlaid processes are spunbonding and meltblowing. A spunlaid process may begin with heating the at least one polymer resin at least to its softening point, or to any temperature suitable for the extrusion of the polymer resin. The polymer resin may be heated to a temperature ranging from about 180° C. to about 260° C. The polymer resin may be heated from about 220° C. to about 250° C.

Spunbonded fibers may be produced by any of the known techniques including but not limited to general spun-bonding, flash-spinning, needle-punching, and water-punching processes. Exemplary spun-bonding processes are described in Spunbond Technology Today 2—Onstream in the 90's (Miller Freeman (1992)), U.S. Pat. No. 3,692,618 to Dorschner et al., U.S. Pat. No. 3,802,817 to Matuski et al., and U.S. Pat. No. 4,340,563 to Appel et al., each of which is incorporated herein by reference in its entirety.

Meltdown fibers may be produced by any of the known techniques. For example, meltblown fibers may be produced by extruding the at least one polymer resin and attenuating the streams of resin by hot air to form fibers with a fine diameter and collecting the fibers to form spunlaid webs. One example of a meltblown process is generally described in U.S. Pat. No. 3,849,241 to Buntin, which is incorporated by reference herein in its entirety.

The filler may be incorporated into the polymer resin using conventional methods. For example, the filler may be added to the polymer resin during any step prior to extrusion, for example, during or prior to the heating step. In another embodiment, a “masterbatch” of at least one polymer resin and filler may be premixed, optionally formed into granulates or pellets, and mixed with at least one additional virgin polymer resin before extrusion of the fibers. The additional virgin polymer resin may be the same or different from the polymer resin used to make the masterbatch. In certain embodiments, the masterbatch comprises a higher concentration of the particulate filler, for instance, a concentration ranging from about 20 to about 75 wt %, than is desired in the final product, and may be mixed with the polymer resin in an amount suitable to obtain the desired concentration of filler in the final spunlaid fiber product. For example, a masterbatch comprising about 50 wt % coated calcium carbonate may be mixed with an equal amount of the virgin polymer resin to produce a final product comprising about 25 wt % coated calcium carbonate. The masterbatch may be mixed and pelletized using suitable apparatus. For example, a ZSK 30 Twin Extruder may be used to mix and extrude the coated calcium carbonate and polymer resin masterbatch, and a Cumberland pelletizer may be used to optionally form the masterbatch into pellets.

Once the particulate filler or masterbatch is mixed with the polymer resin, the mixture may be extruded continuously through at least one spinneret to produce long filaments. The extrusion rate may vary according to the desired application. In one embodiment, the extrusion rate ranges from about 0.3 g/min to about 2.5 g/min. In another embodiment, the extrusion rate ranges from about 0.4 g/min to about 0.8 g/min.

The extrusion temperature may also vary depending on the desired application. For example, the extrusion temperature may range from about 180 to about 260° C. The extrusion temperature may range from about 220 to about 250° C. The extrusion apparatus may be chosen from those conventionally used in the art, for example, the Reicofil 4 apparatus produced by Reifenhauser. The spinneret of the Reicofil 4, for example, contains 6800 holes per metre length approximately 0.6 mm in diameter.

After extrusion, the filaments may be attenuated. Spunbonded fibers, for example, may be attenuated by high-speed drafting, in which the filament is drawn out and cooled using a high velocity gas stream, such as air. The gas stream may create a draw force on the fibers that draws them down into a vertical fall zone to the desired level. Meltblown fibers may, for example, be attenuated by convergent streams of hot air to form fibers of fine diameter.

After attenuation, the fibers may be directed onto a foraminous surface, such as a moving screen or wire. The fibers may then be randomly deposited on the surface with some fibers laying in a cross direction, so as to form a loosely bonded web or sheet. In certain embodiments, the web is held onto the foraminous surface by means of a vacuum force. At this point, the web may be characterized by its basis weight, which is the weight of a particular area of the web, expressed in grams per square meter (gsm). The basis weight of the web may range from about 10 to about 55 gsm. The basis weight of the web may range from about 12 to about 30 gsm.

Once a web is formed, it may be bonded according to conventional methods, for example, melting and/or entanglement methods, such as thermal point bonding, ultrasonic bonding, hydroentanglement, and through-air bonding. Thermal point bonding is a commonly used method and generally involves passing the web of fibers through at least one heated calender roll to form a sheet. In certain embodiments, thermal point bonding may involve two calendar rolls where one roll is embossed and the other smooth. The resulting web may have thermally embossed points corresponding to the embossed points on the roll.

After bonding, the resulting sheet may optionally undergo various post-treatment processes, such as direction orientation, creping, hydroentanglement, and/or embossing processes. The optionally post-treated sheet may then be used to manufacture various nonwoven products. Methods for manufacturing nonwoven products are generally described in the art, for example, in The Nonwovens Handbook, The Association of the Nonwoven Industry (1988) and the Encyclopedia of Polymer Science and Engineering, vol 10, John Wiley and Sons (1987).

Spunlaid fibers may have an average diameter ranging from about 0.5 μm to about 35 μm or more. The spunbonded fibers may have a diameter ranging from about 5 μm microns to about 35 μm. The spunbonded fibers may have a diameter of about 15 μm. The spunbonded fibers may have a diameter of about 16 μm. The meltblown fibers may have a diameter ranging from about 0.5 μm to about 30 μm. The meltblown fibers may have a diameter of about 2 μm to about 7 μm. The meltblown fibers may have a smaller diameter than spunbonded fibers of the same or a similar composition. The spunbonded or meltblown fibers may range in size from about 0.1 denier to about 120 denier. The fibers may range in size from about 1 denier to about 100 denier. The fibers may range in size from about 1 to about 5 denier. The fibers may be about 100 denier in size.

### BRIEF DESCRIPTION OF THE FIGURES

The invention will now be described, by way of example only and without limitation, with reference to the following Figures and Examples, in which:

FIGS. 1a and 1b show graphs of 96 recovery through a 100 μm screen and a 48 μm screen respectively versus feed rate (kg/hr) for materials sifted in a centrifugal sifter in accordance with Example 1;

FIG. 2 shows a graph of pressure against time in relation to a Wayne pressure rise test for 70 wt % filled masterbatch containing un-screened and dry screened calcium carbonate in accordance with Example 2;

FIG. 3 illustrates data in connection with the pressure rise of 70 wt % filled masterbatch containing un-screened and dry screened calcium carbonate versus amount of coarse particles in CaCO₃ feed in accordance with Example 2.

### EXAMPLES

### Test Methods and Samples

Calcium carbonate A is a ground natural calcium carbonate (sourced from a deposit in Europe) coated with stearic acid possessing a d₅₀ of about 1.5 μm. Calcium carbonate B is a ground natural calcium carbonate coated with stearic acid possessing a d₅₀ of about 1 μm. Calcium carbonate C is a ground natural calcium carbonate (sourced from a US deposit) coated with stearic acid possessing a d₅₀ of about 1.5 μm. Calcium carbonate D is a ground natural calcium carbonate possessing a d₅₀ of about 1.5 μm. Kaolin A is a hydrous china clay possessing a d₅₀ of about 1.5 μm and calcined clay A is a calcined kaolin possessing a d₅₀ of about 2 μm.

Unless otherwise stated the particulate mineral was sifted in a Kek-Gardner K650C centrifugal sifter fitted with a nylon screen possessing square holes of the size indicated.

The sifted material and the residues were collected for analysis. The amount of coarse particles was checked by dispersing the sifted material into Isopropyl alcohol (IPA) and screening the mineral dispersion through a 38 μm mesh screen possessing square holes obtained from Endecotts Ltd, Lombard Road, London, SW19 3TZ. The sifted material and any residues were analysed using optical microscopy, and in some cases Infra-Red and EDX for clarification.

### Example 1

A range of particulate materials was fed through a K650C centrifugal rotary sifter from Kek-Gardner using a range of screen mesh sizes (100 μm, 53 μm, 48 μm, 41 μm, 30 μm). The throughput was calculated from the amount of material being screened and collected with time, while the recovery was calculated by weighing the amount of product and rejects. The sifted material and the residues were collected for analysis and the results are shown in Table 1.

For the unsifted samples (Calcium carbonate A or calcium carbonate B or calcium carbonate C), the amount of coarse residues was 3 ppm or greater than 3 ppm and contained mainly a mixture of magnetite and hard calcite particles. For the sifted product only a few particles were found after screening (equivalent to less than 1 ppm).

The results showed that calcium carbonate A sifted with a 53 μm screen had 0.6 ppm of particles above 38 μm (after IPA dispersion) which were mainly magnetite and calcite.

Calcium carbonate A sifted with a 30 μm screen had less than 0.2 ppm particles above 38 μm, which means that only 4 large particles were found in a sample of 500 g. The analysis of the rejects showed a much higher concentration of large particles (ranging from 200 ppm to 5.8 wt %), hence confirming that the rotary sifter was efficient at removing coarse particles. Calcium carbonate B sifted with a 30 μm screen also had less than 0.2 ppm particles above 38 μm.

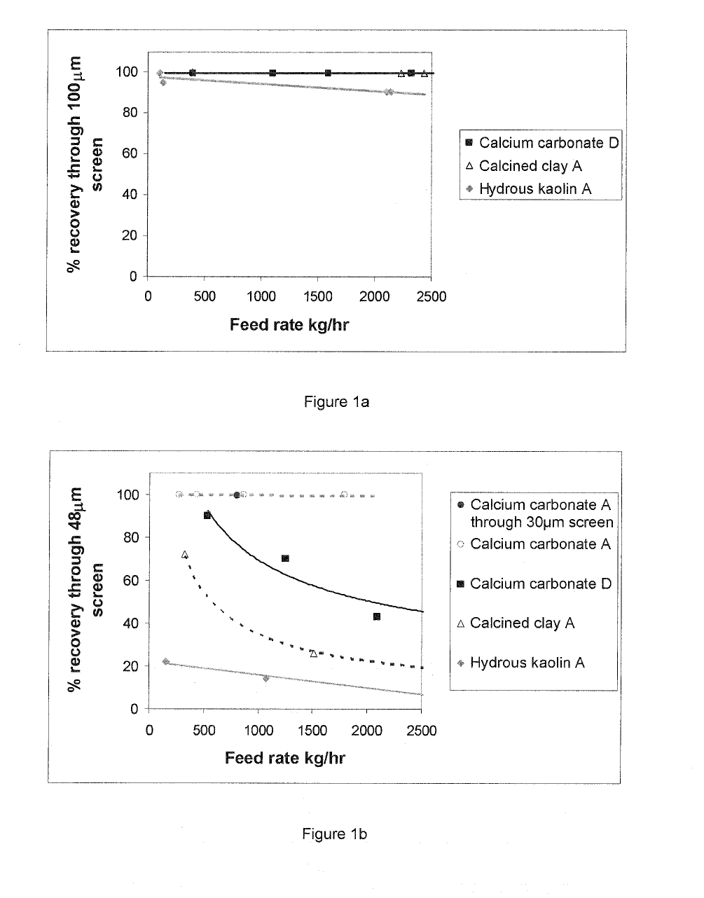

Some of the results obtained in connection with recovery are shown in FIGS. 1a and 1b which show graphs of 96 recovery through a 100 μm screen and a 48 μm screen respectively versus feed rate (kg/hr) for materials sifted in a centrifugal sifter in accordance with Example 1.

The results indicated that large amounts of particulate material may be sifted at high rates and the resulting particulate filler contained very low amounts of coarse material as defined herein. In particular, the results showed that the equipment was successful in producing a very clean GCC with close to zero particles above 38 μm.

### Example 1a

Calcium carbonate A was fed through an Attritor DCM300 mill classifier at a rate of 450 kg/hr and the recovery was 98%. The number of coarse particles collected which were greater than 38 μm was 3.3 ppm which was similar to the amount of coarse particles in the feed.

### Example 1b

Calcium carbonate A was fed through an Attritor CM500 mill classifier at a rate ranging from about 1000 kg/hr to about 1300 kg/hr. A suitable mill speed and mill drive frequency were 4367 rpm and 53 Hz respectively. A suitable air flow was about 3200 am³/h and a suitable range of outlet and inlet temperatures was about 54° C. to 59° C. (outlet) and 24° C. to 30° C. (inlet) respectively. The number of coarse particles collected which were greater than 38 μm was between about 0 ppm and 4 ppm, including 2.9 ppm. The recovery was 76.7%.

### Example 1c

Calcium carbonate A was fed through a Comex UCX-200 air classifier. A recovery of between about 64% and 92% was achieved and the number of coarse particles collected was generally acceptable. A suitable rotor speed ranged from about 4000 rpm to about 5000 rpm. A suitable total air flow was about 620 am³/h to about 695 am³/h.

### Example 1d

Calcium carbonate A was fed through a Deltasizer DS2 air classifier (Metso). The number of coarse particles was significantly lower than the feed, i.e. ranging from 0.6 ppm to 1.2 ppm (the feed contained about 6 ppm). The recovery ranged from 77.5% to 87.5%. A suitable rotor speed ranged from about 4000 to about 5200 rpm. A suitable total air flow was about 1100 am³/h to about 1400 am³/h.

TABLE 1

| | | | | | | IPA screening | |
|---|---|---|---|---|---|---|---|
| | | | | | | Sifted | |
| | | | | | | product | Rejects |
| | Screen | Feed | Product | Rejects | Recovery | Particle >38 | Particle >38 |
| Filter | (μm) | (kg · hr⁻¹) | (kg · hr⁻¹) | (kg · hr⁻¹) | (%) | μm (ppm) | μm (wt %) |
| Calcium | not | — | — | — | — | 3 | |
| carbonate A | sifted | | | | | | |
| Calcium | 53 | 404 | 402 | 2.4 | 99.4 | | |
| carbonate A | | 867 | 864 | 2.6 | 99.7 | | |
| | | 1048 | 1044 | 4.3 | 99.6 | 0.6 | 0.39 |
| | | 1783 | 1776 | 6.6 | 99.6 | | |
| Calcium | 48 | 273 | 273 | 0.3 | 99.9 | <0.5 | |
| carbonate A | | 432 | 432 | 0.5 | 99.9 | | |
| | | 867 | 864 | 3.2 | 99.6 | | |
| | | 1788 | 1782 | 5.7 | 99.7 | | |
| Calcium | 41 | 268 | 267 | 1.2 | 99.6 | | |
| carbonate A | | 501 | 498 | 2.7 | 99.5 | | |
| | | 892 | 888 | 3.6 | 99.6 | | |
| | | 1524 | 1518 | 6.1 | 99.6 | | |
| Calcium | 30 | 195 | 189 | 5.9 | 97.0 | | |
| carbonate A | | 400 | 390 | 10.0 | 97.5 | | |
| | | 800 | 796 | 3.4 | 99.6 | <0.1 | 0.21 |
| | | 839 | 822 | 16.9 | 98.0 | <0.2 | 0.04 |
| | | 1492 | 1488 | 4.2 | 99.7 | | 0.16 |
| Calcium | 15 | 261 | 258 | 3 | 98.8 | <1 | |
| carbonate A | | 318 | 303 | 15 | 95.1 | <1 | |
| | | 380 | 330 | 50 | 86.8 | | 0.004 |
| Calcium | not | | | | | 4.5 | |
| carbonate B | sifted | | | | | | |
| Calcium | 30 | 552 | 550 | 1.3 | 99.8 | <0.2 | 0.40 |
| carbonate B | | | | | | | |
| Calcium | 15 | 238 | 238 | 0.5 | 99.8 | <1 | 0.006 |
| carbonate B | | | | | | | |
| Calcium | not | | | | | 0.5 | |
| carbonate C | sifted | | | | | | |
| Calcium | 30 | 569 | 550 | 18.6 | 96.7 | <0.2 | 0.11 |
| carbonate C | | | | | | | |
| Calcium | 100 | 396 | 396 | 0.2 | 100.0 | | |
| carbonate D | | 1105 | 1104 | 0.9 | 99.9 | | |
| | | 1594 | 1593 | 0.8 | 100.0 | | |
| | | 2324 | 2322 | 1.9 | 99.9 | | |
| Calcium | 48 | 534 | 482 | 52 | 90 | | |
| carbonate D | | 1248 | 876 | 372 | 70 | | |
| | | 2088 | 900 | 1188 | 43 | | |
| | | 3042 | 1350 | 1692 | 44 | | |
| Kaolin A | 100 | 105.8 | 105.6 | 0.19 | 99.8 | | |
| | | 1326.6 | 1260 | 66.6 | 95 | | |
| | | 2106 | 1908 | 198 | 91 | | |
| | | 2142 | 1935 | 207 | 90 | | |
| Kaolin A | 48 | 154 | 33.6 | 120 | 22 | | |
| | | 1074 | 150 | 924 | 14 | | |
| | | 2844 | 144 | 2700 | 5 | | |
| Calcined | 100 | 391 | 391 | 0.05 | 100.0 | | |
| clay A | | 2235 | 2232 | 3.2 | 99.9 | | |
| | | 2431 | 2421 | 9.9 | 99.6 | | |
| | | 3374 | 3366 | 7.5 | 99.8 | | |
| Calcined | 48 | 324 | 233 | 91 | 72 | | |
| clay A | | 1512 | 396 | 1116 | 26 | | |
| | | 3258 | 558 | 2700 | 17 | | |

### Example 2

A test was conducted to measure the pressure through an extruder of compound containing 70 wt % of particulate filler. The Wayne pressure test consists of extruding 1 kg of 70 wt % calcium carbonate filled compound through a fine filter screen of given particle size (400 mesh, corresponding to 37 μm) which is attached to a coarse, supporting screen (60 mesh or 250 μm). The test was run on masterbatches prepared using a Werner & Pfeiderer ZSK40 twin screw extruder. The Wayne extruder is first run with unfilled resin (ideally of similar melt flow properties to the resin used for the masterbatch). The masterbatch is then incorporated and the increase in pressure behind the screen monitored. The line is then flushed with unfilled resin and the final pressure compared with the initial pressure, the difference being called “pressure rise”,

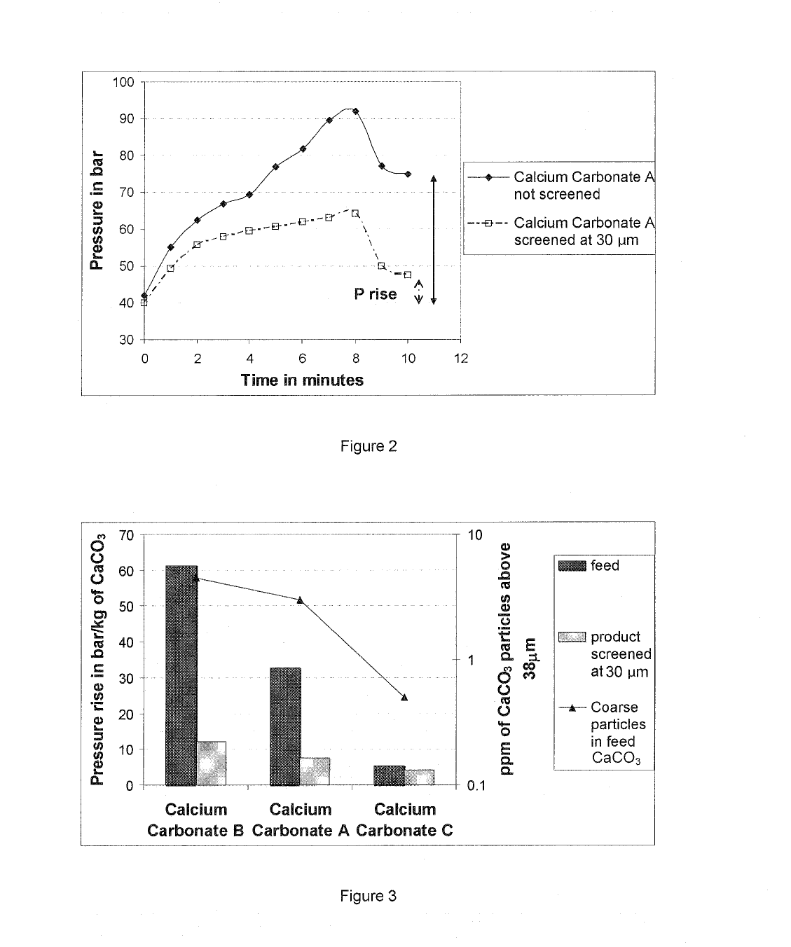

FIG. 2 is an example of pressure whilst extruding a 70 wt % masterbatch containing Calcium carbonate A (i) not screened and (ii) dry screened at 30 μm, both processed under the same conditions. The screened calcium carbonate gives lower pressure than the unscreened calcium carbonate. FIG. 3 is a comparison of pressure rise for various calcium carbonates before and after dry screening (from Table 1) showing a decrease in pressure rise with decreasing amount of coarse particles.

### Example 3

The pressure rise of a masterbatch containing 70 wt % of particulate fillers extruded under different compounding conditions was investigated. Table 2 provides data in connection with the pressure rise of 70 wt % filled masterbatch prepared under different compounding conditions. The data indicates that the particulate calcium carbonate in accordance with certain embodiments of the present invention (“screened 30 μm”) give lower pressure rise (p rise) under a given set of compounding conditions when the mineral is well dispersed. Under particular process conditions (Compounding conditions no. 3) which reduces the amount of agglomerates, very low pressure rise can be obtained through very fine screens (25 μm or 37 μm) using the calcium carbonate processed in accordance with certain embodiments of the present invention.

TABLE 2

| | Com- | Pressure | Pressure | |
|---|---|---|---|---|
| | pound- | rise through | rise through | Nature of |
| | ing con- | 25 μm screen | 37 μm screen | residues on |
| Mineral | ditions | bar/kg | bar/kg | 37 μm screen |
| Calc. Carb A | 1 | 123 | 28 | Agglomerate & |
| | | | | hard particles |
| Calc. Carb A | 1 | >190 | 162 | Mainly |
| screened 30 μm | | | | agglomerates |
| Calc. Carb A | 3 | >190 | | |
| Calc. Carb A | 3 | 23 | | |
| screened 30 μm | | | | |
| Calc. Carb B | 1 | >190 | 104 | Hard particles |
| | | | | & agglomerates |
| Calc. Carb B | 1 | 131 | 40 | Hard particles |
| screened 30 μm | | | | & agglomerates |
| Calc. Carb B | 3 | 62 | | |
| Calc. Carb B | 3 | 25 | 0 | |
| screened 30 μm | | | | |
| Calc Carb A* | 3 | 25 | | |

*Air classified according to Example 1d

### Example 4

Investigations were conducted regarding the runnability of compounds containing 10 wt % to 15 wt % particulate filler on a REICOFIL® 4M hygiene spunbond line. For spunbond processing, calcium carbonate is added as a resin concentrate (or masterbatch), typically at 70 wt % loading of calcium carbonate in polypropylene. The resin concentrate is diluted in polypropylene resin Basell Moplen HP561R to achieve lower CaCO₃ loading in fibres. The REICOFIL® line was run at 300 kg/hr for unfilled polypropylene resin, 205 kg/hr for 10 wt % filled polypropylene and 197 kg/hr for 15 wt % filled polypropylene. All calcium carbonate concentrates were shown to give good spinnability at 10 wt % and 15 wt %, but significant differences in melt pressure were observed through the 400# (37 μm) screen used in the extruder. For unfilled polypropylene, the melt pressure was typically 88 bars at the beginning of the run. After addition of calcium carbonate at 20.5 kg/t (for a 10 wt % loading), the screen in the extruder was changed and the melt pressure monitored. For some of the compounds, the melt pressure was shown to rise and the running time was taken as the time to reach 110 bars.

Table 3 provides data in connection with the runnability of masterbatch comprising calcium carbonate on REICOFIL® 4M hygiene line. The results indicate that the runnability data for calcium carbonate according to embodiments of the invention was increased significantly from less than 2 hours up to over 3 hours with no signs of increased pressure. The entries referred to as “screened 30 μm” and “screened 15 μm” in Table 3 relate to calcium carbonate in accordance with embodiments of the invention. The amount of residues collected on the screen was also measured after immersing a section of each screen in hot xylene, removing the dissolved fraction (containing resin and well-dispersed calcium carbonate) and washing to collect the insoluble residues. The residues were weighed, normalised for the amount of calcium carbonate being extruded and inspected by optical microscopy to determine the composition (specifically agglomerate versus large particle content). Large pressure rises were associated with a large number of residues on the screen.

TABLE 3

| | | Reicofil | Reicofil | |
|---|---|---|---|---|
| | Masterbatch | screen | running | Nature of |
| | compounding | residues/ | time/ | residues on |
| | conditions | ppm | mins | Reicofil screen |
| Calc. Carb. A | 2 | 8 | 23 | Mainly |
| | | | | hard particles |
| Calc. Carb. C | 2 | 12 | 19 | Mainly |
| | | | | hard particles |
| Calc. Carb. B | 2 | 6 | 77 | Hard |
| | | | | particles & |
| | | | | agglomerates |
| Calc. Carb. B | 1 | 5 | 117 | Hard |
| | | | | particles & |
| | | | | agglomerates |
| Calc. Carb. A | 2 | — | 120 | |
| screened 30 μm | | | | |
| Calc. Carb. A | 2 | 3 | 125 | Mainly |
| | | | | agglomerates, |
| | | | | some hard |
| | | | | particles |
| Calc. Carb. A | 3 | — | >150 | — |
| Calc. Carb. A | 3 | — | >>90 | — |
| screened 30 μm | | | | |
| Calc. Carb. A | 3 | — | >>180 | — |
| screened 30 μm | | | | |
| Calc. Carb. A | 3 | — | >>60 | — |
| screened 15 μm | | | | |
| Calc. Carb. A* | 3 | | >>120 | |

*Air classified according to Example 1d

1. A particulate filler comprising less than 3 ppm of particles having a particle size greater than or equal to 40 μm.

2. A particulate filler according to claim 1, wherein the amount of particles having a particle size greater than or equal to 40 μm is less than or equal to 2 ppm.

3. (canceled)

4. (canceled)

5. A particulate filler according to claim 1, wherein the amount of particles having a particle size greater than or equal to 40 μm ranges from 0 ppm to 0.1 ppm.

6. A particulate filler according to claim 1, wherein the particulate filler comprises less than 3 ppm of particles having a particle size greater than 30 μm.

7-10. (canceled)

11. A particulate filler according to claim 1, wherein the filler comprises alkaline earth metal carbonate, metal sulphate, metal silicate, metal oxide metal hydroxide, kaolin, calcined kaolin, wollastonite, bauxite, talc or mica, including combinations thereof.

12. A particulate filler according to claim 11, wherein the filler is coated or treated.

13. A particulate filler according to claim 12, wherein the filler is coated with one or more fatty acids or salts or esters thereof, wherein the fatty acids may be selected from stearic acid, palmitic acid, behenic acid, montanic acid, capric acid, lauric acid, myristic acid, isostearic acid and cerotic acid.

14. A particulate filler according to claim 1, wherein the particulate filler is calcium carbonate or coated calcium carbonate.

15. A particulate filler according to claim 14, wherein the calcium carbonate is coated with stearic acid.

16. A particulate filler according to claim 1, wherein the filler is ground calcium carbonate (GCC) or coated GCC.

17. A particulate filler according to claim 1, wherein the d₅₀ of the filler ranges from 0.5 μm to 5 μm.

18. (canceled)

19. A composition comprising the particulate filler according to claim 1.

20. A composition according to claim 19, wherein the composition is a polymer composition and the polymer composition comprises a polymer resin.

21-27. (canceled)

28. A polymer film formable from or formed from a polymer composition according to claim 20, wherein the filler is present at a concentration of ranging from 2 to 55 wt % by weight of the final polymer film.

29-31. (canceled)

32. A polymer film according to claim 28, wherein the polymer film is a breathable film, wherein the mean thickness of the breathable film ranges from 5 μm to 25 μm.

33-35. (canceled)

36. A spunlaid fiber comprising a polymer resin and a particulate filler according to claim 1.

37-39. (canceled)

40. Any one of a diaper, feminine hygiene product, adult incontinence product, packaging material, wipe, towel, dust mop, industrial garment, medical drape, medical gown, foot cover, sterilization wrap, table cloth, paint brush, napkin, trash bag, personal care article, ground cover, and filtration media comprising a spunlaid fiber according to claim 36 or a nonwoven fabric comprising a spunlaid fiber according to claim 36.

41. A staple fiber comprising the particulate filler according to claim 1.

42. A carpet comprising a staple fiber according to claim 41.

43. A carpet comprising the particulate filler according to claim 1.

44-52. (canceled)
